(19) United States
(12) Patent Application Publication
(10) Pub. No.: US 2013/0293590 A1
(43) Pub. Date: Nov. 7, 2013

(54) MOBILE TERMINAL COMPRISING A GRAPHICAL USER INTERFACE

(71) Applicants: Sylvain Gommier, Leuven (BE); Jérôme Nadel, Leuven (BE)

(72) Inventors: Sylvain Gommier, Leuven (BE); Jérôme Nadel, Leuven (BE)

(73) Assignee: OPTION, Leuven (BE)

(21) Appl. No.: 13/822,232

(22) PCT Filed: Sep. 12, 2011
(86) PCT No.: PCT/EP11/65789

§ 371 Date: Jun. 19, 2013

(30) Foreign Application Priority Data
Sep. 10, 2010 (FR) 1057196

(51) Int. Cl. G09G 5/373

(52) U.S. Cl. CPC G09G 5/373
USPC 345/666

(57) ABSTRACT

A mobile terminal comprises a screen adapted to display graphic objects, including widgets corresponding to their respective applications, said widgets being partial interfaces of the applications to which they correspond in each case. The mobile terminal (4.4) determines the dimensions of at least one variable-size widget and/or of at least one graphic representation of at least one widget, based on at least one request notification for at least one application to which at least one of the widgets displayed corresponds. The mobile terminal then updates (4.5) the widget display based on the dimensions it has determined. The dimensions of widgets and/or graphic representations of widgets therefore change in line with the requests for the applications to which they correspond.

The present invention relates to a mobile terminal comprising a screen adapted to display graphic objects including widgets. The present invention likewise relates to a method implemented by this mobile terminal. The present invention likewise relates to a computer program enabling the method to be implemented and storage means for storing a computer program of this kind.

Mobile terminals such as mobile phones, personal digital assistants (PDA's), multimedia players or also tablet personal computers (tablet PC's) are proliferating. These mobile terminals are becoming ever more complex and offering an ever increasing number of functionalities. These functionalities are accessible in the form of software modules referred to as applications.

When a user turns on a mobile terminal of this kind, it typically displays a home page or a home page panel. In fact, given the multitude of applications available on a mobile terminal of this kind and the smaller screen size, it is commonplace today for this home page to be divided into a plurality of panels. The mobile terminal screen then allows a panel to be displayed among the plurality of panels and the mobile terminal offers a means of navigating which makes it possible to move from one panel to another.

Each panel on the home page may contain icons enabling applications to be launched. An icon is a static graphic object which allows a corresponding application to be launched with its full user interface when the user interacts with said ion. For example, it is possible for an application to be launched with its full user interface by pressing a finger on the icon which corresponds to the application, provided the mobile terminal has a touchscreen.

When an application is launched with its full user interface, it occupies the whole of the mobile terminal screen and is displayed independently of the panel containing the icon from which it has been launched. It then provides its functionalities in their entirety.

Each panel of the home page may also contain widgets (contracted form of window gadget). A widget is a partial application interface, in other words a widget does not occupy the whole of the screen and only provides some of the functionalities of the application. A widget of this kind may be arranged as an icon on a panel. In short, it is therefore an intermediary between an icon and an application launched with its full user interface. A widget is linked to a panel and allows an application to be launched with its full user interface, as in the case of an icon. Moreover, it has the dynamic nature of the application and allows interaction with the user by providing him with some of the functionalities proposed by the application.

Widgets of this kind are found, for example, in the operating system for Android (trademark) mobile terminal developed by Google Inc.

It is moreover commonplace for the terminal user to be able to add new applications which he purchases and install them on his mobile terminal. This means that the number of graphic objects present on the home page panels, whether these are icons or widgets, constantly increases. It then becomes difficult for the user to pick out and quickly access the information or functionalities that are particularly important to him from among all these graphic objects.

It is desirable for these various disadvantages of the state of the art to be addressed.

The invention relates to a mobile terminal comprising a screen adapted to display graphic objects, including widgets corresponding to their respective applications, said widgets being partial interfaces of the applications to which they correspond in each case. The mobile terminal comprises means of determining the dimensions of at least one variable-size widget and/or of at least one variable-size graphic representation of at least one widget, said means being adapted to determine the dimensions of each variable-size widget and/or of each variable-size graphic representation, based on at least one request notification for at least one application from among those to which the widgets displayed correspond.

The dimensions of widgets and/or graphic representations of widgets therefore change based on the requests for the applications to which they correspond. According to a first example, the more an application is requested, the larger the corresponding widget becomes, and the less this application is requested, the smaller the corresponding widget becomes. According to a second example, the more an application is requested, the smaller the widgets corresponding to the other applications become. According to a third example, the more an application is requested, the larger the corresponding widget becomes, and the smaller the widgets corresponding to the other applications become. According to a fourth example, the more a functionality of an application is requested, the larger the corresponding graphic representation becomes and the less this functionality is requested, the smaller the corresponding graphic representation becomes. According to a fifth example, the more a functionality is requested, the smaller the graphic representations corresponding to the other functionalities of the same application, in other words, of the same widget become. According to a sixth example, the more a functionality is requested, the larger the corresponding graphic representation becomes, and the smaller the graphic representations corresponding to the other functionalities of the same application, in other words, of the same widget, become.

According to a particular embodiment, said means of determination are adapted to determine the dimensions of each variable-size widget based on at least one request notification for the application to which said widget corresponds and/or at least one request notification for at least one application to which at least one other displayed widget corresponds.

Hence, a widget for which the corresponding application is requested is brought to the fore and/or a widget corresponding to another application is put in the background. These two aspects may be combined, so as to manage the distribution of the screen display area based on the widgets and requests for their applications.

According to a particular embodiment, said means of determination are adapted to determine the dimensions of each variable-size graphic representation referred to based on at least one request notification for a functionality to which said variable-size graphic representation corresponds and/or at least one request notification for at least one functionality to which at least one other graphic representation of the widget, to which each aforementioned variable-size graphic representation belongs, corresponds.

A graphic representation for which the corresponding functionality is requested is therefore brought to the fore and/or a graphic representation corresponding to another functionality is put in the background. These two aspects may be combined, so as to manage the distribution of the screen display area for the widget comprising these graphic representations.

According to a particular embodiment, at least one request notification for an application is a triggering event, triggering a functionality of the application.

Hence, each time an application is requested by an event, this event may be taken into account to determine the dimensions of the corresponding widget or of another widget which is also displayed. This event may be internal to the application, i.e. intrinsic to the application, or external to the application, i.e. provided by a module or another application of the mobile terminal.

According to a particular embodiment, said triggering event is an event from the following group:
a detection event for notifications to be put together for on-screen display;
a receiving event for notifications emanating from a communication network, said mobile terminal comprising communication means via said communication network.

For example, if an application determines that a notification must be provided to a user of the mobile terminal, the event that has allowed detection of this notification to be provided is taken into account when determining the dimensions of at least one widget. It is possible, for example, to enlarge the widget (in relation to a default size or in relation to the size that it was prior to the event being detected) to indicate that such a notification is available.

Moreover, if, for example, one or a plurality of messages is received via the communication network, the event that has allowed the receipt of this/these message(s) is taken into account in determining the dimensions of at least one widget. It is possible, for example, to enlarge the widget (in relation to a default size or in relation to the size that it was prior to the event being detected) to indicate that such a message has been received.

It is also possible to determine the dimensions of the widget based on a history of such events. For example, it is possible to enlarge a widget (in relation to a default size) corresponding to an application that has received a large number of messages via the communication network over a given period.

According to a particular embodiment, the mobile terminal is of a type comprising communication means via a communication network and the determination means are adapted to determine the dimensions of at least one variable-size widget and/or at least one variable-size graphic representation in proportion to a number of receiving events relating to notifications emanating from said communication network which are waiting to be dealt with.

It is therefore possible to increase or reduce the bringing to the fore of widgets and/or graphic representations based on the notifications yet to be dealt with. These notifications may be waiting to be dealt with by a user of the mobile terminal, e.g. alerts waiting to be read or waiting to be dealt with by a module or an application of the mobile terminal, e.g. an application needs to be launched in order to deal with notifications placed on hold by another application.

According to a particular embodiment, the notification on the increase or reduction in the dimensions of the widget is sent to the widget (or the corresponding application) to allow it to adapt its representation and/or the means of interaction offered to the user based on the new dimensions. For example, a widget associated with a messaging application only displaying the number of unread messages when its dimensions are small may also display the title of the last message received when the repeated request, of which it forms the object, leads to an increase in its dimensions and, moreover, it is also able to display a reply text input field and a send button when a strong request takes its dimensions to their maximum.

According to a particular embodiment, the mobile terminal comprises configuration means adapted to configure the extent to which said triggering event influences the dimensions of the variable-size widget and/or the variable-size graphic representation for each variable-size widget and/or each variable-size graphic representation.

It is therefore possible to increase or reduce the bringing to the fore of widgets depending on user preferences. A mobile terminal user may then decide which widget or which widgets are brought to the fore more quickly than others when their corresponding applications are requested.

According to a particular embodiment, for the dimensions of said variable-size widget, at least one request notification referred to for an application belongs to the following group:
notification relating to the usage frequency of the application with a full user interface;
notification relating to the usage duration of the application with a full user interface, over a given period;
notification relating to the number of times the application has been launched with a full user interface.

Hence, each time an application is requested by a user, this request may be taken into account to determine the dimensions of the corresponding widget or of another widget displayed. It is therefore possible to bring to the fore the widgets corresponding to the applications most frequently used by the user. This allows the mobile terminal to be personalized, something that evolves with the usage habits of the user.

According to another particular embodiment, at least one request notification for an application belongs to the following group:
notification relating to the usage frequency of the application over a given period, with a user interface or by means of one or a plurality of associated widgets;
notification relating to the usage duration of the application over a given period, with a user interface or by means of one or a plurality of associated widgets;
notification relating to the number of times over a given period that one or a plurality of widgets associated with the application has been installed on a panel of the home page, moved or deleted from a panel of the home page;
notification relating to the frequency or duration over a given period in which a plurality of notifications are processed by the application;
notification relating to the data volume or data transfer rate updated through processing by the application or processed by the application;
notification relating to the state of the mobile terminal system, for example linked to its capacity to guarantee nominal or constrained performance of the application;
notification relating to the state of another application linked, for example, to the history of the notification of this other application;
notification relating to the environment of the mobile terminal, gathered by means of one or a plurality of sensors with which the terminal is equipped;
notification relating to the history of interactions between the user and the terminal input interfaces and/or relating to their preferences in the use of one method of interaction relative to the others.

According to a particular embodiment, said determination means are adapted to add or delete at last one graphic representation of at least one variable-size widget.

A greater number of functionalities can therefore be offered to the user by a variable-size widget when the dimensions of said widget increase.

The invention likewise relates to a method implemented by a mobile terminal comprising a screen adapted to display graphic objects, including widgets corresponding to their respective applications, said widgets being partial interfaces of the applications to which they correspond in each case. The method comprises a stage for determining the dimensions of at least one variable-size widget and/or at least one variable-size graphic representation of at least one widget, the dimensions of each variable-size widget and/or of each variable-size graphic representation being determined based on at least one request notification for at least one application among those to which the displayed widgets correspond.

The invention likewise relates to a computer program which may be stored on a medium and/or downloaded from a communication network, in order to be read by a computer system or a processor. This computer program includes instructions on implementing the aforementioned method when said program is executed by a computer system or a processor. The invention likewise relates to storage means comprising a computer program of this kind.

The aforementioned characteristics of the invention, as well as others, will become clearer on reading the following description of an exemplary embodiment, said description being made in relation to the attached drawings, among which:

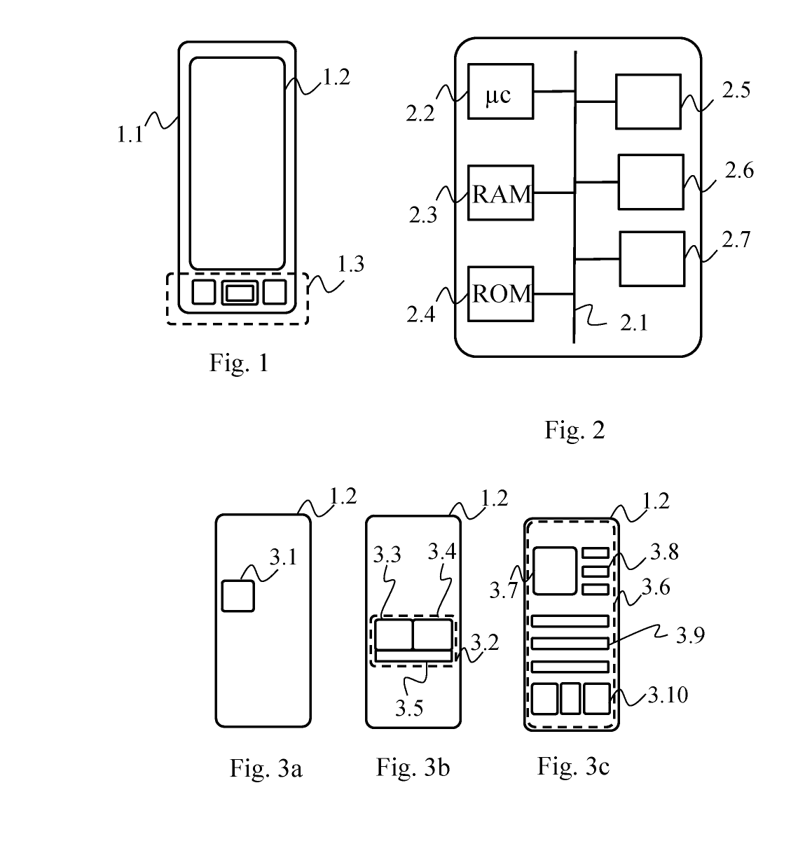

FIG. 1 illustrates a mobile terminal having a screen, in which the invention can be implemented;

FIG. 2 illustrates schematically the architecture of the mobile terminal in FIG. 1;

FIG. 3a illustrates schematically an icon displayed on the screen of the mobile terminal in FIG. 1;

FIG. 3b illustrates schematically a widget displayed on the screen of the mobile terminal in FIG. 1;

FIG. 3c illustrates schematically an application launched with its full user interface displayed on the screen of the mobile terminal in FIG. 1;

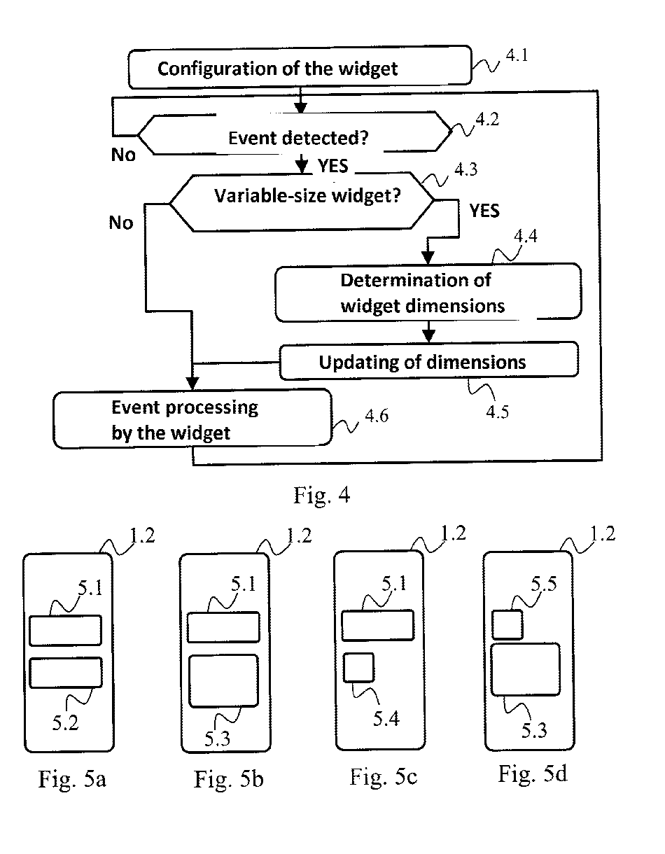

FIG. 4 illustrates schematically an algorithm implemented by the mobile terminal in FIG. 1;

FIG. 5a illustrates schematically a plurality of widgets displayed in a first instant on the screen of the mobile terminal in FIG. 1;

FIG. 5b illustrates schematically a plurality of widgets displayed in a second instant on the screen of the mobile terminal in FIG. 1;

FIG. 5c illustrates schematically a plurality of widgets displayed in a third instant on the screen of the mobile terminal in FIG. 1;

FIG. 5d illustrates schematically a plurality of widgets displayed in a fourth instant on the screen of the mobile terminal in FIG. 1;

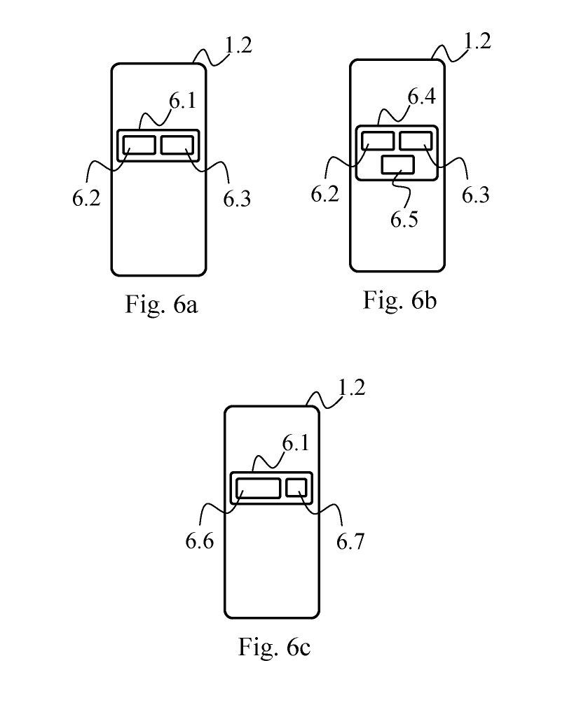

FIG. 6a illustrates schematically a widget displayed in a fifth instant on the screen of the mobile terminal in FIG. 1;

FIG. 6b illustrates schematically a widget displayed in a sixth instant on the screen of the mobile terminal in FIG. 1;

FIG. 6c illustrates schematically a widget displayed in a seventh instant on the screen of the mobile terminal in FIG. 1.

So that a mobile terminal user is able to pick from among all the widgets displayed on his mobile terminal and access the notifications or functionalities which are particularly important to him, it is proposed that the widget sizes should be varied based on request notifications for the applications to which they correspond in each case.

These request notifications may be notifications relating to events received by the applications concerned, which in this respect request them. These events then act as triggers for respective functionalities of the applications concerned. These request notifications may be notifications relating to the usage frequency or duration of these applications or to the number of times the application has been launched with its full user interface. The request is then in the hands of the user.

In a particular embodiment, the more events an application receives, the more it is requested as a result and the more the dimensions of the corresponding widget grow. Conversely, the fewer it receives, the less it is requested as a result and the more the dimensions of the corresponding widget diminish.

Similarly, in a particular embodiment, the more an application is used by the user, the more it is requested as a result and the more the dimensions of the corresponding widget grow. Conversely, the fewer it receives, the less it is requested as a result and the more the dimensions of the corresponding widget diminish.

It is naturally possible that only one of the dimensions of a widget of this kind will vary based on request notifications for the application to which it corresponds.

The widgets in which the dimensions change are referred to below as variable-size widgets.

Hence, certain widgets stand out among the totality of widgets displayed by the mobile terminal. The user is therefore able to determine more quickly which widgets are likely to provide him with the notifications or functionalities which are particularly important to him.

FIG. 1 illustrates a mobile terminal in which the invention can be implemented.

A mobile terminal 1.1 traditionally comprises a screen 1.2 on which a user is able to display graphic elements relating to applications and interact with them. This interaction may take place directly if the screen 1.2 is a touchscreen or by means of a group of keys 1.3 or a keyboard.

The mobile terminal 1.1 is, for example, a mobile phone, a personal digital assistant (PDA), a tablet personal computer, etc. In a preferred embodiment, the mobile terminal 1.1 is a mobile phone.

FIG. 2 illustrates schematically the architecture of the mobile terminal 1.1.

The mobile terminal 1.1 comprises, linked by a communication bus 2.1:
a processor, microprocessor, microcontroller (labelled μc) or CPU (Central Processing Unit) 2.2;
a live RAM (Random Access Memory) 2.3;
a dead ROM (Read Only Memory) 2.4;
a storage medium reader 2.5, such as an SD card reader (Secure Digital Card);
interface means 2.6 with a communication network, such as a mobile phone network, for example; and
man-machine interface means 2.7, particularly enabling the screen 1.2 and all the keys 1.3 to be managed.

The microcontroller 2.2 is capable of executing instructions uploaded into the RAM 2.3 from the ROM 2.4, from an external memory (not shown), from a storage medium, such as an SD card or other, or from a communication network. When the mobile terminal 1.1 is switched on, the microcontroller 2.2 is capable of reading instructions from the RAM 2.3 and executing them. These instructions form a computer program. This computer program causes all or part of the algorithm described below in relation to FIG. 4 to be implemented by the microcontroller 2.2.

All or part of the algorithm described below in relation to FIG. 4 may be implemented in software form through the execution of a collection of instructions by a programmable machine, such as a DSP (Digital Signal Processor) or a microcontroller, such as the microcontroller 2.2, or it may be implemented in hardware form by a machine or a dedicated component, such as an FPGA (Field-Programmable Gate Array) or an ASIC (Application-Specific Integrated Circuit).

FIGS. 3a to 3c are intended to illustrate schematically the differences in terms of display on the screen 1.2, between an icon, a widget and an application to which they relate, launched with its full user interface.

FIG. 3a illustrates schematically an icon displayed on the screen 1.2 of the mobile terminal 1.1.

The screen 1.2 of the mobile terminal 1.1 displays a home page panel on which is placed an icon 3.1. The icon 3.1 allows an application to which said icon 3.1 corresponds to be launched with its full user interface. It is possible to launch this application with its full user interface by pressing a finger on the icon 3.1, provided the screen 1.2 is a touchscreen. Once the application has been launched with its full user interface, it occupies the entire screen 1.2, as shown in FIG. 3c.

FIG. 3b illustrates schematically an icon displayed on the screen 1.2 of the mobile terminal 1.1.

The screen 1.2 of the mobile terminal 1.1 displays a home page panel on which is placed a widget 3.2. The widget 3.2 allows an application to which said widget 3.2 corresponds to be launched with its full user interface. It is possible to launch this application with its full user interface by pressing a finger on a zone 3.3 of the widget 3.2, provided the screen 1.2 is a touchscreen. Once the application has been launched, it occupies the entire screen 1.2, as shown in FIG. 3c.

Pressing the finger on a zone 3.4 of the widget 3.2, when the screen 1.2 is a touchscreen, allows the user to activate functionalities of the application to which the widget 3.2 corresponds. This zone 3.4 is, for example, made up of graphic representations of control buttons, such as audio media play and pause activation buttons, if the widget 3.2 corresponds to an audio media player application.

The widget 3.2 may also comprise a zone 3.5 in which information intended for the user is displayed. Within the framework of a widget corresponding to an audio media player application, this zone 3.5 may be used to indicate to the user the title of the audio content being played and/or other information on this audio content.

FIG. 3c illustrates schematically an application launched with its full user interface and displayed on the screen 1.2 of the mobile terminal 1.1.

An application 3.6 is launched from the icon 3.1 in FIG. 3a or from the widget in FIG. 3b. The application 3.6 with its full user interface occupies the entire screen 1.2. The user then has access to all the functionalities of the application 3.6.

The application 3.6 may comprise graphic representations of control buttons 3.8 and 3.10. If the application 3.6 is an audio media player, these control buttons are, for example, audio media play, pause, repeat, audio content selection, etc. activation buttons.

The application 3.6 may also comprise zones 3.8 and 3.9 in which information intended for the user is displayed. If the application 3.6 is an audio media player, these zones 3.8 and 3.9 may be used to indicate to the user the title of the audio content currently being played, the name of the artist, or to display an image relating to the audio content being played.

FIG. 4 illustrates schematically an algorithm implemented by the mobile terminal 1.1 according to an embodiment of the invention.

Let us consider a widget such as the widget 3.2.

In one stage 4.1, the mobile terminal 1.1 configures the widget 3.2. This stage is implemented, for example, when the widget 3.2 is installed. This configuration particularly relates to the variable nature of the dimensions of the widget 3.2. The mobile terminal 1.1 may apply a configuration to the widget by default or may interact with the user in order to define the configuration to be applied to the widget. The user may therefore indicate whether the widget 3.2 is of fixed or variable size.

The widget 3.2 is then configured and displayed on the screen 1.2 with default dimensions.

In a following stage 4.2, the mobile terminal 1.1 determines whether an event relating to the application to which the widget 3.2 corresponds is detected. If this is the case, a stage 4.3 is executed; if not, the stage 4.2 is withdrawn.

During the stage 4.3, the mobile terminal 1.1 determines whether the widget 3.2 is of variable size, based on the configuration carried out at stage 4.1. If the widget 3.2 is variable in size, a stage 4.4 is carried out; if not, the system moves straight to stage 4.6, during the course of which the event is processed by the widget 3.2.

An event of this kind relating to the application to which the widget 3.2 corresponds is, in a particular embodiment, a detection event for notifications to be put together for display on the screen 1.2. If, for example, the widget 3.2 corresponds to a calendar application, the widget 3.2 may detect that a calendar event, such as a birthday reminder or a reminder that a particular job has to be done, is going to occur within a given period calculated from the present time. The widget 3.2 may then have to display this calendar event in a dedicated zone of the widget 3.2, such as zone 3.5 in FIG. 3b.

An event of this kind relating to the application to which the widget 3.2 corresponds is, in a particular embodiment, a receiving event for notifications emanating from a communication network. For example, the mobile terminal 1.1. is a mobile phone and the widget 3.2 corresponds to a message or alert receiving application. The widget 3.2 may then have to display a message or alert received or provide an indication that a message or an alert of this kind has been received, in a dedicated zone of the widget 3.2, such as the zone 3.5 in FIG. 36.

At stage 4.4, the mobile terminal 1.1 determines the dimensions of the widget 3.2, following the detection of the event during stage 4.2. The dimensions of the widget 3.2 are potentially intended to change, following detection of the event, independently of the fact that the event is actually displayed by the widget in the subsequent stage 4.6. During the following stage 4.5, the dimensions of the widget 3.2 are updated, where necessary, and the stage 4.6 is then executed.

If, for example, the widget 3.2 corresponds to a calendar application, the dimensions of the widget 3.2 may vary based on the number of calendar events that have passed and/or are coming up. It is therefore possible to change the dimensions of the widget 3.2 in proportion to the number of calendar events that have passed and/or are coming up in a given period. The greater the number of calendar events present over this period, the larger the widget 3.2 is. The smaller the number of calendar events, the smaller the widget 3.2.

In a more general way, therefore, the dimensions of the widget 3.2 may vary in proportion to a number of events received over a past period and/or envisaged over a future period.

If, for example, the mobile terminal 1.1 is a mobile phone and if the widget 3.2 corresponds to an application for receiving messages or alerts, the dimensions of the widget 3.2 may vary according to the number of messages or alerts waiting to be read.

In a more general way, therefore, the dimensions of the widget 3.2 may vary in proportion to a number of events waiting to be dealt with by the user and/or by the application to which the widget 3.2 corresponds.

The mobile terminal 1.1 therefore changes the dimensions of the widget 3.2 based on the events detected and relating to the application to which the widget 3.2 corresponds. The mobile terminal 1.1 may alter the dimensions of the widget 3.2 based on an event or a history of events over a given period.

In a particular embodiment, at stage 4.1 the user may define which are the events intended to be processed by the widget 3.2 or by the application to which it corresponds which may have an effect on its dimensions. It is also possible for the user to define the extent to which these events have an effect on its dimensions.

For example, the user may regard alerts of a certain type, such as those relating to the stock exchange, as being more important than alerts of a second type, such as those relating to sports results. In this case, the first type of alerts could have a more noticeable effect on the dimensions of the widget 3.2 corresponding to the application for receiving alerts, as already mentioned, than those of the second type. Moreover, if the user regards alerts of a third type, such as those relating to new cinema releases, as being of little importance, then they may have no effect on the dimensions of the widget 3.2.

In a particular embodiment, stages 4.2 to 4.5 are implemented periodically. The event detected at stage 4.2 is then an expiry event of a delay period of predefined duration. Because this event does not correspond to processing to be carried out by the application to which the widget 3.2 corresponds, the stage 4.6 does not have to be executed in this case. This periodic implementation allows account to be taken of the fact, for example, that the application has not been requested over this predefined period and then reduce its dimensions.

In a particular embodiment, the dimensions of the widget 3.2, for which the application to which it corresponds is not used with its full user interface for a given period and/or has not processed an event over this period, may be made smaller, even down to the size of an icon. In a particular embodiment, the widget 3.2 may be replaced by an icon, such as the icon 3.1 in FIG. 3a.

It is also possible for the mobile terminal 1.1 to change the dimensions of the widget 3.2 according to the application usage frequency to which the widget corresponds with its full user interface. For example, the higher this frequency, the larger the widget 3.2 is.

It is also possible for the mobile terminal 1.1 to change the dimensions of the widget 3.2 based on the usage duration of the application to which the widget corresponds with its full user interface. For example, the longer this usage duration, the larger the widget 3.2 is.

It is also possible for the mobile terminal 1.1 to change the dimensions of the widget 3.2 based on the number of times the application to which the widget corresponds has been launched with its full user interface. For example, the greater this number, the bigger the widget 3.2.

It is also possible for information on the usage frequency of the application, the usage duration of the application and/or the number of times the application has been launched with its full user interface to be used to define the extent to which the detection of events to be processed by the widget 3.2 has an effect on its dimensions.

It should be noted that the maximum size of the widget 3.2 depends on the amount of space remaining free on the home page panel on which the widget 3.2 is positioned.

FIGS. 5a to 5c are intended to illustrate schematically the development in time of the dimensions of widgets displayed on the screen 1.2 of the mobile terminal 1.1.

FIG. 5a illustrates schematically a display of widgets in a first instant on the screen 1.2 of the mobile terminal 1.1.

The screen 1.2 displays two widgets 5.1 and 5.2. Each widget 5.1 and 5.2 is displayed according to its respective default dimensions. The widget 5.1 is not a variable-size widget. Its dimensions therefore remain fixed over time. The widget 5.2 is a variable-size widget. Its dimensions therefore change over time.

FIG. 5b illustrates schematically a display of widgets in a second instant on the screen 1.2 of the mobile terminal 1.1.

The screen 1.2 displays two widgets 5.1 and 5.3. The widget 5.1 corresponds to the widget with the same reference number in FIG. 5a. Its dimensions have remained the same. The widget 5.3 corresponds to the widget 5.2 in FIG. 5a. Its dimensions have changed so as to bring it to the fore on the home page panel on which it is positioned.

FIG. 5c illustrates schematically a display of widgets in a third instant on the screen 1.2 of the mobile terminal 1.1.

The screen 1.2 displays two widgets 5.1 and 5.4. The widget 5.1 corresponds to the widget with the same reference number in FIG. 5a. Its dimensions have remained the same. The widget 5.4 corresponds to the widget 5.2 in FIG. 5a. Its dimensions have changed so as to put it in the background on the home page panel on which it is positioned. So even if the widget 5.1 is not of variable size, it can be brought to the fore by putting the widget 5.2, which is itself variable in size, into the background.

FIG. 5d illustrates schematically a display of widgets in a fourth instant on the screen 1.2 of the mobile terminal 1.1.

The screen 1.2 displays two widgets 5.3 and 5.5. The widget 5.3 corresponds to the widget with the same reference number in FIG. 5b. Its dimensions have changed so as to bring it to the fore on the home page panel on which it is positioned. The widget 5.5 corresponds to the widget 5.1 in FIG. 5a. Its dimensions have also changed so as to put it in the background on the panel of the home page on which it is positioned. A situation of this kind may occur when the application to which the widget 5.2 corresponds has been requested such that the dimensions of the widget 5.2 must increase. So that the widget 5.2 is actually brought to the fore, the dimensions of the widget 5.1 may be reduced. Hence, the dimensions of the widget 5.1 change based on requests for the application to which the widget 5.2 corresponds.

It is also possible that a situation of this kind comes about so that the surface of the home page panel can be shared. If the surface of the home page panel is occupied in such a way that there is insufficient space remaining for the dimensions of the widget 5.2 to be increased, it may be necessary to reduce the dimensions of the widget 5.1. Space on the home page panel is freed up as a result to allow the dimensions of the widget 5.2 to be increased.

Changes in the respective dimensions of these widgets are then coordinated by a centralized display management module on the mobile terminal, for example. This module takes account, for example, of the total surface of the home page panel, the surface occupied by each of the widgets and notifications concerning requests for the applications to which the widgets correspond in each case.

The centralized display management module may, moreover, coordinate in a preferential manner the respective dimensions of widgets juxtaposed or positioned at a smaller distance from a predefined threshold.

The centralized display management module may also adjudicate between widgets, the dimensions of which must develop in line with the requests for the applications corresponding to the widgets displayed. Adjudication of this kind may, for example, take into account user preferences and/or a history of the requests for applications of the widgets for which there is to be adjudication.

The centralized display management module may also consider changing the dimensions of variable-size widgets within limits set by upper and/or lower limit values.

It is therefore possible to bring a widget to the fore or put it in the background by changing its dimensions based on requests for the application to which it corresponds. The user is then able to pick out more quickly and easily from among the widgets displayed on each home page panel on his mobile terminal and this enables him to access notifications which are particularly important to him more quickly and easily. It is also possible to bring a widget to the fore or put it in the background by altering its dimensions based on requests for the applications to which the widgets sharing the same panel correspond.

Hence, it is possible for a user to personalize each panel on the home page of his mobile terminal automatically by bring to the fore those widgets containing information which is important to him.

In a particular embodiment, in order to optimize the surface of the home page panel on which it is positioned, a widget may, apart from having its dimensions changed, be moved within this panel. A movement of this kind must not, however, be disruptive to the user and must therefore have a smaller range compared with the panel dimensions. It is therefore possible to optimize the occupation of the panel surface by variable-size widgets, fixed-size widgets and icons by maintaining the points of reference which the user has at his disposal to access notifications and applications which are important to him.

FIGS. 6a to 6c are intended to illustrate schematically a change in time in the dimensions of graphic representations within a widget displayed on the screen 1.2 of the mobile terminal 1.1.

FIG. 6a illustrates schematically a display of a widget 6.1 in a fifth instant on the screen 1.2 of the mobile terminal 1.1.

The widget 6.1 comprises graphic representations 6.2 and 6.3. The graphic representations 6.2 and 6.3 are variable in size and correspond to functionalities of the application to which the widget 6.1 corresponds. The graphic representations 6.2 and 6.3 represent control keys, for example, such as audio media play and pause controls, if the widget 6.1 corresponds to an audio media player application. The widgets 6.2 and 6.3 may also correspond to zones in which information intended for the user is displayed.

FIG. 6b illustrates schematically a display of a widget 6.4, in a sixth instant, on the screen 1.2 of the mobile terminal 1.1.

The widget 6.4 results from a modification of the widget 6.1. At least one of the dimensions of the widget 6.1 has been modified as previously described, this being based on at least one request notification for at least one application among those to which the widgets displayed on the screen 1.2 of the mobile terminal 1.1 correspond.

The graphic representations 6.2 and 6.3 in FIG. 6a can be found in the widget 6.4. The widget 6.4 also includes an additional graphic representation 6.5. The fact that the dimensions of the widget 6.1 have increased allows the user to access, via the widget 6.4, more functionalities of the application to which the widget 6.4 corresponds. Conversely, if the dimensions of the widget 6.4 diminish, fewer functionalities can be provided for the user. A choice can be made in a pre-established fashion to define the functionalities to be provided via the widget when its dimensions change. This choice may also be made based on a request level for the functionalities of the application to which the widget corresponds.

FIG. 6c illustrates schematically a display of the widget 6.1 in a sixth instant on the screen 1.2 of the mobile terminal 1.1.

The widget 6.1 comprises the graphic representations 6.6 and 6.7. The graphic representations 6.6 and 6.7 correspond to the graphic representations 6.2 and 6.3, respectively, in FIG. 6a, the dimensions of which have changed.

The dimensions of the graphic representation 6.2 have changed, so that it is brought to the fore in the widget 6.1. The dimensions of the graphic representation 6.3 have changed, so that it is put in the background in the widget 6.1. The dimensions of a sub-group of graphic representations displayed in the widget 6.1 may change based on the requests for functionalities of the application to which the widget 6.1 corresponds.

In order to implement the displays in FIGS. 6a to 6c, the stage 4.4 described above in relation to FIG. 4 is modified, so as to allow the dimensions of the widget concerned and/or of the graphic representations contained in this widget concerned to be changed. During the stage 4.4 the mobile terminal 1.1 therefore determines the dimensions of the widget concerned and/or of the graphic representations contained in said widget, following the detection of the event at stage 4.2. The dimensions of the widget concerned and/or of the graphic representations contained in said widget are therefore potentially intended to alter following detection of the event, irrespective of the fact that the event is actually displayed by the widget in the previous stage 4.6. At stage 4.5, the dimensions of the widget concerned and/or of the graphic representations contained in said widget are updated where necessary.

Likewise, stage 4.1 may be adapted to allow the variable-size graphic representations to be configured. In stage 4.1 the mobile terminal 1.1 therefore configures the widget concerned and/or the graphic representations of said widget. This stage is implemented, for example, when the widget concerned is installed. This configuration particularly concerns the variable nature of the dimensions of the widget concerned and/or of the graphic representations of said widget. The mobile terminal 1.1 may apply a configuration by default to the widget and/or to the graphic representations or may interact with the user, in order to define the configuration to be applied to the widget and/or to the graphic representations. The user may therefore indicate whether the widget concerned and/or the graphic representations of said widget are of a fixed or variable size.

In a particular embodiment, at stage 4.1, the user may define which of the events processed by the application corresponding to the widget concerned may influence the dimensions of the widget concerned and/or of the graphic representations of said widget. It is also possible that the user may define the extent to which these events influence these dimensions.

1. A mobile terminal (1.1) comprising a screen (1.2) adapted to display graphic objects (3.1; 3.2), including widgets (5.1; 5.2) corresponding to their respective applications, said widgets being partial interfaces of the applications to which they correspond in each case, characterized in that it comprises means of determining the dimensions of at least one variable-size widget and/or of at least one variable-size graphic representation of at least one widget, said means being adapted to determine the dimensions of each variable-size widget and/or of each variable-size graphic representation, based on at least one request notification for at least one application from among those to which the widgets displayed correspond.

2. The mobile terminal mobile according to claim 1, characterized in that said determination means are adapted to determine the dimensions of each variable-size widget based on at least one request notification for the application to which said widget corresponds and/or at least one request notification for at least one application to which at least one other displayed widget corresponds.

3. The mobile terminal according to either of the claims 1, characterized in that said determination means are adapted to determine the dimensions of each variable-size widget referred to based on at least one request notification for a functionality to which said variable-size graphic representation corresponds and/or at least one request notification for at least one functionality to which at least one other graphic representation of the widget, to which each aforementioned variable-size graphic representation belongs, corresponds.

4. The mobile terminal according to claim 1, characterized in that at least one request notification for an application is a triggering event, triggering a functionality of the application.

5. The mobile terminal according to claim 4, characterized in that said triggering event is an event from the following group:
a detection event for notifications to be put together for on-screen display;
a receiving event for notifications emanating from a communication network, said mobile terminal comprising communication means via said communication network.

6. The mobile terminal according to claim 4, of a type comprising communication means via a communication network, characterized in that the determination means are adapted to determine the dimensions of at least one variable-size widget and/or at least one variable-size graphic representation in proportion to a number of receiving events relating to notifications emanating from said communication network which are waiting to be dealt with.

7. The mobile terminal according to claim 4, characterized in that it comprises configuration means adapted to configure the extent to which said triggering event influences the dimensions of the variable-size widget and/or the variable-size graphic representation for each variable-size widget and/or each variable-size graphic representation.

8. The mobile terminal according to claim 1, characterized in that for the dimensions of said variable-size widget, at least one request notification referred to for an application belongs to the following group:
notification relating to the usage frequency of the application with a full user interface;
notification relating to the usage duration of the application with a full user interface, over a given period;
notification relating to the number of times the application has been launched with a full user interface.

9. The mobile terminal according to claim 1, characterized in that at least one request notification for an application belongs to the following group:
notification relating to the usage frequency of the application over a given period, with a user interface or by means of one or a plurality of associated widgets;
notification relating to the usage duration of the application over a given period, with a user interface or by means of one or a plurality of associated widgets;
notification relating to the number of times over a given period that one or a plurality of widgets associated with the application has been installed on a panel of the home page, moved or deleted from a panel of the home page;
notification relating to the frequency or duration over a given period in which a plurality of notifications are processed by the application;
notification relating to the data volume or data transfer rate updated through processing by the application or processed by the application;
notification relating to the state of the mobile terminal system, for example linked to its capacity to guarantee nominal or constrained performance of the application;
notification relating to the state of another application linked, for example, to the history of the notification of this other application;
notification relating to the environment of the mobile terminal, gathered by means of one or a plurality of sensors with which the terminal is equipped;
notification relating to the history of interactions between the user and the terminal input interfaces and/or relating to their preferences in the use of one method of interaction relative to the others.

10. The mobile terminal according to claim 1, characterized in that said determination means are adapted to add or delete at last one graphic representation of at least one variable-size widget.

11. A method implemented by a mobile terminal (1.1) comprising a screen (1.2) adapted to display graphic objects (3.1; 3.2), including widgets (5.1; 5.2) corresponding to their respective applications, said widgets being partial interfaces of the applications to which they correspond in each case, characterized in that it comprises a stage for determining (4.4) the dimensions of at least one variable-size widget and/or at least one variable-size graphic representation of at least one widget, the dimensions of each variable-size widget and/or of each variable-size graphic representation being determined based on at least one request notification for at least one application among those to which the displayed widgets correspond.

12. A computer program, characterized in that it includes instructions on implementing the method according to claim 10 through a mobile terminal (1.1), when said program is executed by a processor (2.2) of said mobile terminal.

13. Storage means, characterized in that they store a computer program comprising instructions on implementing the method according to claim 10 through a mobile terminal (1.1), when said program is executed by a processor (2.2) of said mobile terminal.
